(19) United States
(12) Patent Application Publication
(10) Pub. No.: US 2005/0070327 A1
(43) Pub. Date: Mar. 31, 2005

(54) Cellular phone having a function of receiving a television broadcasting wave

(75) Inventor: Akira Watanabe, Hanno-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/948,413

(22) Filed: Sep. 23, 2004

(30) Foreign Application Priority Data
Sep. 30, 2003 (JP) 2003-339861

(51) Int. Cl. H04B 7/00

(52) U.S. Cl. 455/552.1; 455/550.1; 455/566

(57) ABSTRACT

In a flip cellular phone which is capable of receiving a television signal, when the cellular phone is brought to an open state after detecting an incoming call while receiving a television signal with the cellular phone kept in the closed state, the television receiving operation ceases automatically for communication by telephone, and thereby the user of the cellular phone is not required to execute a troublesome operation to quit receiving the television signal. The cellular phone does not cease receiving the television signal while the user is talking on the phone and outputs telephone talking voice in place of the television sound. Therefore, the user can enjoy watching the television program while talking on the phone. Further, since the cellular phone displays a television image and caller's information simultaneously, the user can confirm the caller's information.

### CROSS-REFERENCE TO RELATED APPLICATIONS

This application is based upon and claims the benefit of priority from prior Japanese Patent Application No. 2003-339861, filed Sep. 30, 2003, the entire contents of which are incorporated herein by reference.

### BACKGROUND OF THE INVENTION

1. Field of the Invention

The present invention relates to a cellular phone and more particularly to a cellular phone having a function of receiving a television broadcasting wave.

2. Description of the Related Art

There has been proposed to embed a television broadcasting wave receiving function into a cellular phone. The proposed cellular phone is provided with a tuner for receiving a surface digital broadcasting wave to obtain encoded video and audio data, a memory card or a built-in memory for storing the encoded image and audio data. In this cellular phone, the encoded video and audio data read out from the memory card or the built-in memory or the encoded video and audio data supplied from the tuner are decoded to display a video image on a display of the cellular phone as well as to output sounds through a speaker.

The cellular phone with the television broadcasting wave receiving function can yield new problems. For example, when there is an incoming call while a user is watching a TV program, and the user of the cellular phone gives priority to speaking, the user is forced to miss watching some part of the TV program while speaking by telephone.

To solve the problem mentioned above, another technology has been proposed, which allows the user to watch such part of TV program after finishing speaking by telephone. According to the technology, when there is an incoming call while the user is watching a TV program, the decoded video and audio data of the TV program received while the user is speaking by telephone is stored in the built-in memory, and when the user finishes speaking, the encoded video and audio data is read out so as to reproduce the TV program from the point as the user began speaking by telephone (catch-up reproducing). This technology has been proposed in Japanese Patent Publication No. 2003-111004.

With the technology, however, when there is an incoming call while the user is watching a TV program, the user has to give up watching the TV program and is required to operate the cellular phone to bring the same to a phone-call mode. It will be troublesome for the user to set the cellular phone to the phone-call mode every incoming call, and the user can miss in operation.

Meanwhile, there is left a problem that the cellular phone can not receive the television broadcasting wave once the same is set to the phone-call mode. It will be considered to make the cellular phone display a TV program while used for speaking, but receiving the TV broadcasting wave can often hinder conversation over the phone.

### BRIEF SUMMARY OF THE INVENTION

A recent cellular phone is designed so as to be folded. The cellular phone comprises a cover portion and a body portion, both being connected to each other by a hinge, and can be held in an open state or in a folded state. A display unit is mounted on the cover portion and a display screen displayed on the display unit can be seen only when the cellular phone is held in the open state. When an incoming call is notified, a user uses the cellular phone in the open state for a speaking purpose.

Focused on the structure of the cellular phone, the present invention has been made. The invention has a feature that, in case that an incoming call is detected with the cellular phone held in the folded state while the cellular phone is receiving a TV broadcasting wave, the cellular phone is made to cease receiving the TV broadcasting wave when the same is brought to the open state.

With the arrangement described above, when an incoming call is notified, a user can begin talking using the cellular phone simply by opening the cellular phone without required to turn the TV receiving operation off.

Further, since the user can talk using only a speaker and a microphone of the cellular phone, there is no need for the user to turn the TV receiving operation off while talking by phone and the cellular phone is allowed to keep displaying a video image on its display unit.

The present invention has been made focused on the above arrangement, and has a feature that, in case that an incoming call is detected with the cellular phone held in the folded state while the cellular phone is displaying a video image of a TV program on its display unit and outputting a TV sound, the cellular phone is made to begin to output a telephone conversation in place of the TV sound, when the same is brought to the open state.

With the arrangement described above, even when the cellular phone has received an incoming call and has been brought to a phone-call mode, the user is allowed to continue watching at least a video image on the cellular phone and is not hindered in telephone conversation, because the cellular phone outputs the telephone conversation in place of the TV sound.

It will be more convenient, if the user can confirm caller's information while watching a video image of a TV program, when there is an incoming call.

The present invention has been made focused on the above requirement, and has a feature that, in case that an incoming call is detected with the cellular phone held in the folded state while the cellular phone is receiving a TV signal and displaying a video image of a TV program on its display unit, the cellular phone is made to display information of the incoming call including the caller's information on an empty area of the display unit, when a switch detects that the cellular phone is in the open state.

With the arrangement described above, even when the cellular phone has received an incoming call and has been brought to a phone-call mode, the user is allowed to continue watching at least a video image on the cellular phone and is not hindered in telephone conversation, and further can confirm the caller's information.

### BRIEF DESCRIPTION OF THE SEVERAL VIEWS OF THE DRAWING

FIG. 1A is a front view showing a cellular phone in an open state according to an embodiment of the present invention.

FIG. 1B is a rear view showing the cellular phone in the open state according to the embodiment of the present invention.

FIG. 2 is a block diagram showing a configuration of the cellular phone according to the embodiment of the present invention.

FIG. 3 is a flow chart of processes performed in the cellular phone according to the first embodiment of the present invention.

FIG. 4 is a flow chart of processes performed in the cellular phone according to the first embodiment of the present invention.

FIG. 5 is a flow chart of processes performed in the cellular phone according to the first embodiment of the present invention.

FIG. 6 is a flow chart of processes performed in the cellular phone according to the first embodiment of the present invention.

FIG. 7 is a flow chart of processes performed in the cellular phone according to the first embodiment of the present invention.

FIG. 8 is a flow chart of an incoming-call detecting process performed in the cellular phone according to the first embodiment of the present invention.

FIG. 9 is a flow chart of an incoming-call finishing process performed in the cellular phone according to the first embodiment of the present invention.

FIG. 10 is a flow chart of processes performed in the cellular phone according to the second embodiment of the present invention.

FIG. 11 is a flow chart of processes performed in the cellular phone according to the third embodiment of the present invention.

FIG. 12 is a view showing by way of example a display screen (a TV program and caller data are displayed simultaneously) of the cellular phone according to the third embodiment of the present invention.

### DETAILED DESCRIPTION OF THE INVENTION

First Embodiment of the Invention

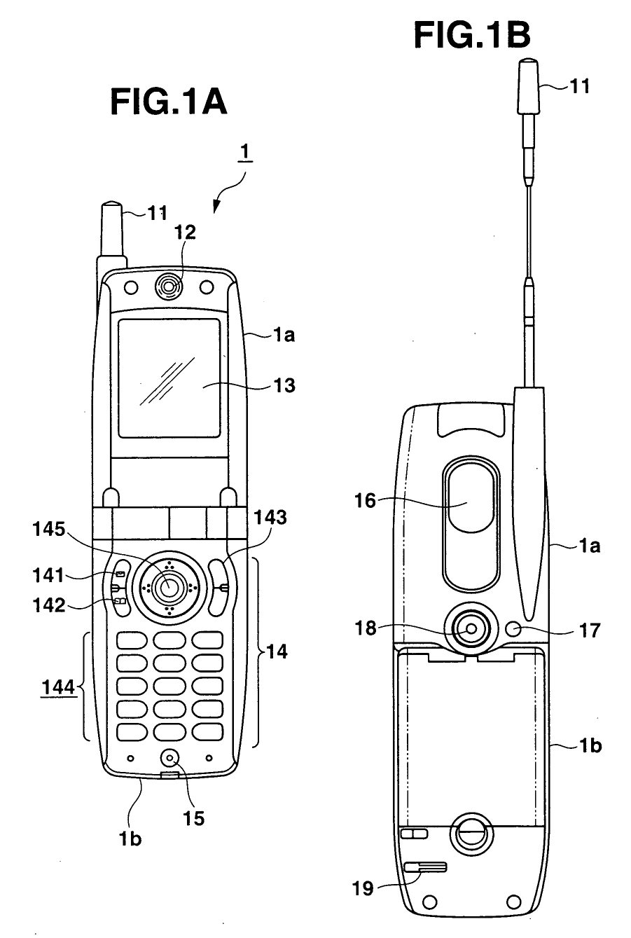

Now, embodiments of the present invention will be described with reference to the accompanying drawings. FIGS. 1A and 1B are a front view and a rear view illustrating an external appearance of a cellular phone 1 in an open state according the embodiment of the present invention. The cellular phone 1 according to the embodiment of the invention comprises a body portion 1b and a cover portion 1a, both of which are connected with a hinge (not shown) and can take two positions, an open position shown in FIGS. 1A and 1B and a closed or folded position. That is, the body portion 1b and the cover portion 1a connected to the former by the hinge and take an open or folded position relatively to other portion. The cover portion 1a is provided with a display unit 13 on its front surface which faces a front surface of the body portion 1b, when the cellular phone 1 is held in the folded state. Meanwhile, the body portion 1b is provided with a key input section 14 on its front surface. When the cellular phone 1 is held in the folded state, the display unit 13 and the key input section 14 are not exposed outwardly and hidden inside but a subsidiary display unit 16 and a speaker 19 are exposed outwardly.

An extensible antenna 11 is provided in a rear surface of the cover portion 1a.

A speaker 12 for outputting sounds is provided on the front surface of the cover portion 1a. The display unit (main display unit) 13 consists of a color liquid crystal display device of 120 dots width by 160 dots height.

The display unit 13 has a resolution in a level substantially equivalent to QVGA, which can display a photograph attached to e-mail and a mail body, simultaneously.

The key input section 14 is provided on the front surface of the body portion 1b, including various function keys (such as a mail key 141, an address key 142, and a function key 143), numeral keys 144, and a shutter key 145. The mail key 141 is operated to start a mail function for displaying a mail menu.

The address key 142 is operated to open an address book for searching for an address to which a mail is to be sent.

The function key 143 is used for instructing a reproduction of a moving image and/or a temporary suspension of the reproduction, when a mail with a moving image is created or a mail with a moving image is confirmed. The numeral keys 144 are used for entering a phone number or characters.

The shutter key 145 starts taking a moving image when it is kept depressed for a certain period of time (about 2 seconds) in a photographing mode.

The subsidiary display unit 16 is provided on the rear surface of the cover portion 1a. An LED 17 is also provided on the rear surface of the cover portion 1a, which emits a light to notify an incoming mail.

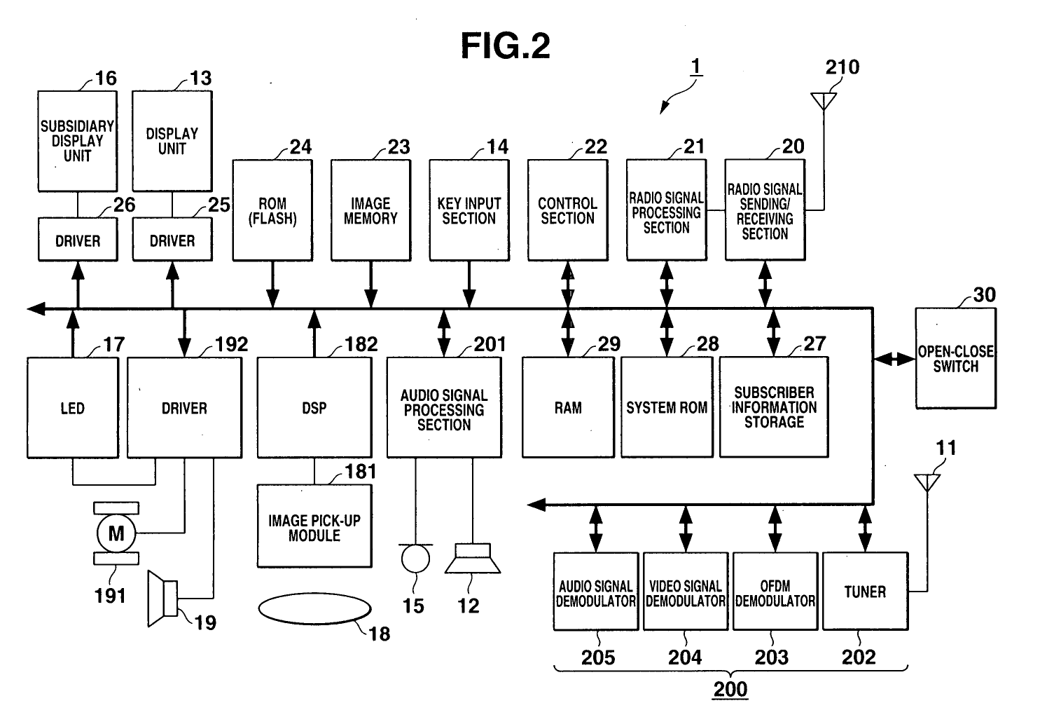

An object lens 18 is installed on the cover portion 1a at a lower portion to the subsidiary display unit 16 as viewed in FIG. 1B. Data made by the object lens 18 is stored on an image-data buffer area provided for example in RAM 29 (Refer to FIG. 2) until the moving-image photographing operation finishes or stored data excesses a certain memory capacity (maximum 100K bytes). When it is detected that data has been stored to the certain capacity, or the shutter-switch depression has been released, data stored in the buffer is compressed to make a compressed file, and the compressed file is stored in an image memory 23 (Refer to FIG. 2).

The alarm speaker 19 serves to notify an incoming call, and is arranged on the rear surface of the body portion 1b so as to be heard even though the cellular phone 1 is kept in the closed or folded state.

FIG. 2 is a block diagram showing a configuration of the cellular phone 1.

A radio signal sending/receiving section 20 serves to transmit and/or to receive a radio voice and/or data signal (mail data signal) via a built-in antenna 210, and to modulate and/or to demodulate the signal. An antenna is for receiving a TV signal.

A radio signal processing section 21 serves to perform processes necessary for a radio communication, including a demodulating process for demodulating the signal received by the radio signal sending/receiving section 20 and a modulating process for modulating a voice and/or data signal to be sent to the radio signal sending/receiving section 20.

A control section 22 serves to control various operations and the whole operation of the cellular phone. The antenna 11 and the antenna 210 may be replaced with each other in their functions, or either of the antenna 11 or 210 may be arranged to perform the functions of the both antennas 11 and 210.

The image memory 23 is for storing image files of image data which are photographed by a photographing section (including the object lens 18 and an image pick-up module 181, DSP 182) and compressed and encoded in accordance with a program stored in an image-processing program, and image files downloaded via WWW.

ROM 24 includes a rewritable Flash ROM, and stores various kinds of programs, as will be described later, that are features of the present invention.

A driver 25 has a buffer corresponding to a display area of the display unit 13, and drives the display unit 13. A driver 26 drives the subsidiary display unit 16.

A subscriber information storage 27 stores profile data including phone numbers for calling another cellular phones and subscriber's identification data (ID).

ROM 28 stores various kinds of programs for the control section 22. RAM 29 stores data necessary as a communication terminal as well as mail data. In particular, RAM 29 is provided with a memory area which serves as a buffer memory for temporarily storing a moving image under the photographing operation.

An open-close switch 30 is a micro-switch which is provided, for example, in the vicinity of the hinge used for holding the cellular phone in the open state or in the closed or folded state. The open-close switch 30 is brought off, when the cellular phone is in the folded state, and turned on, when it is detected that the cellular phone has been brought opened for use.

An audio signal processing section 201 serves to encode a voice signal entered through a microphone 15, and to decode a signal from the radio signal processing section 21 to output a voice through the speaker 12.

An image pick-up module 181 includes CCD or CMOS to generate a color image data.

DSP 182 serves to encode the image data generated by the image pick-up module 181.

A notifying device 192 is a driver for driving the alarm speaker 19, a vibrator 191 and LED 171.

A tuner 202, OFDM (orthogonal frequency division multiplexing) demodulator 203, a video signal demodulator 204 and an audio signal demodulator 205 construct a TV signal receiving section (TV receiver) 200 for receiving a TV broadcasting signal.

The tuner 202 receives a terrestrial digital broadcasting wave, OFDM demodulator 203 demodulates OFDM signal, and the video signal decoder 204 and the audio signal decoder 205 receive the demodulated signal (the coded video data and the coded audio data) from the OFDM demodulator 203.

The video signal decoder 204 decodes the demodulated signal to display a video image on the display unit 13 or on the subsidiary display unit 16, and the audio signal decoder 205 decodes the demodulated signal to output an audio signal through the speaker 12, and thereby a user of the cellular phone can enjoy the TV broadcasting program displayed on the cellular phone.

The control section 22 controls the radio signal sending/receiving section 20 through the audio signal processing section 201 to process a communication signal and also controls the TV signal receiving section 200. More specifically, processes are performed in accordance with a flow chart sown below.

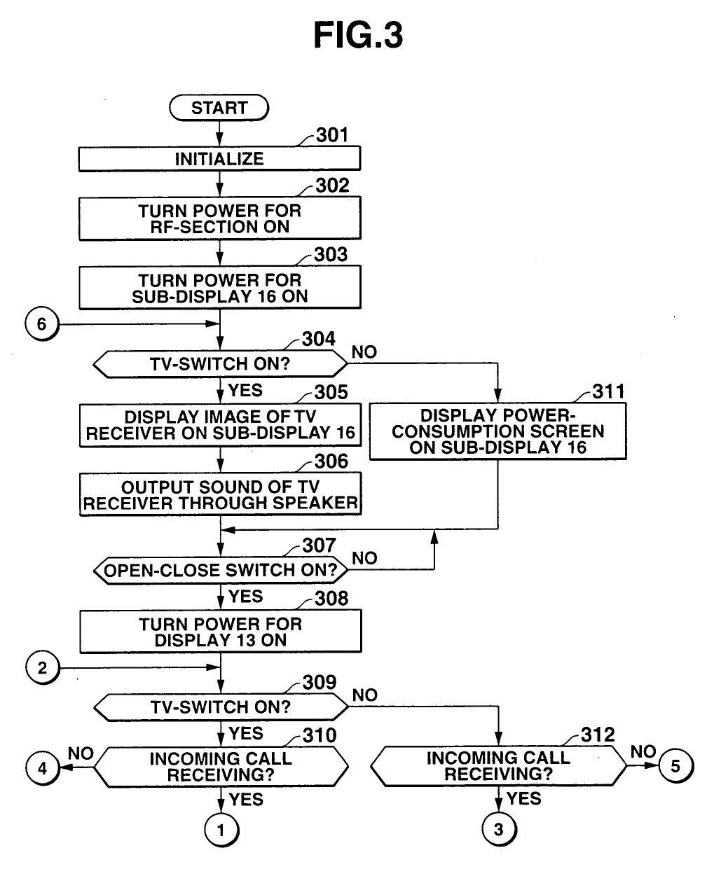

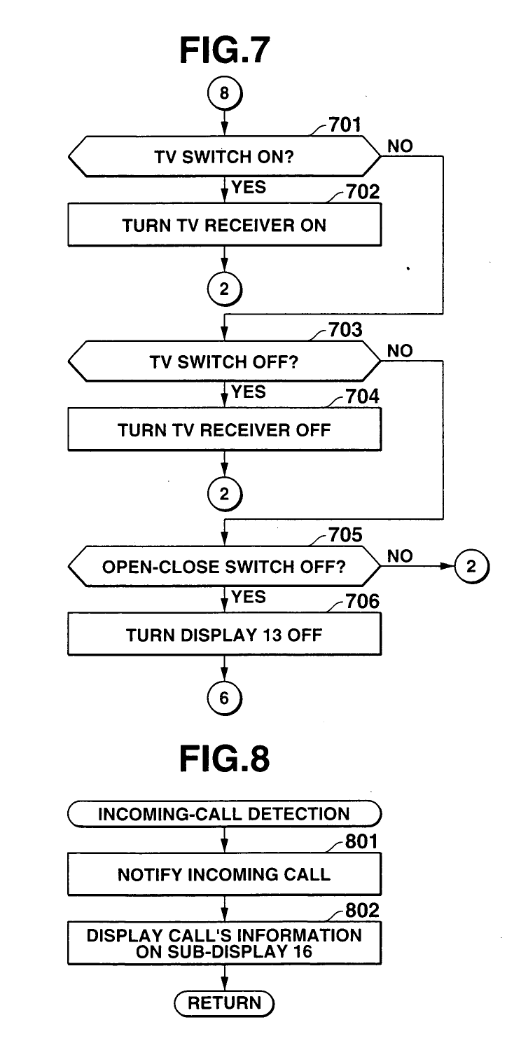

An operation of the cellular phone configured as described above will be described with reference to flow charts shown in FIG. 3 through FIG. 7. FIG. 3 through FIG. 7 are flow charts showing the main processes performed in the cellular phone according to the embodiment of the present invention.

In the cellular phone, when the power is turned on, an initializing process is executed at step 301 of FIG. 3. Then, the power for an FR section including the radio signal sending/receiving section 20 is turned on at step 302, and the power for the subsidiary display unit 16 (second display unit) is turned on at step 303.

The control section 22 judges at step 304 whether a TV switch (not shown) has been turned on or not. This TV switch is provided on the cellular phone, and is operated for TV reception. The TV switch may be one specialized for TV reception, or either of switches in the key input section 14 may be used as the TV switch.

When it is determined at step 304 that the TV switch has been turned on (YES at step 304), the control section 22 displays on the subsidiary display unit 16 (second display unit) a video image output from the TV signal receiving section 200 at step 305, and outputs through the speaker 12 a sound sent from the TV signal receiving section 200 at step 306.

When it is determined at step 304 that the TV switch has not been turned on (NO at step 304), the control section 22 displays on the subsidiary display unit 16 a screen concerning power consumption at step 311.

After the process of step 306 has been executed, the control section 22 judges at step 307 whether or not the open-close switch 30 has been turned on. When it is determined at step 307 that the open-close switch 30 is not turned on (NO at step 307), the control section 20 keeps displaying the video image on the subsidiary display unit 16. When it is determined at step 307 that the open-close switch 30 is turned on (YES at step 307), the control section 22 displays the video image on the display unit 13 or brings the cellular phone to a phone-call mode.

More specifically, the control section 22 keeps displaying the video image from the TV signal receiving section 200 on the subsidiary display unit 16 (second display unit) unless the user does not open the cellular phone while the TV switch is on with the cellular phone kept in the closed state.

When it is determined at step 307 that the open-close switch 30 is turned on (YES at step 307), the display unit 14 is turned on at step 308. Then, it is judged at step 309 whether the TV switch has been turned on or not. When it is determined at step 309 that the TV switch is turned on (YES at step 309), it is judged at step 310 whether or not the cellular phone is receiving an incoming call. When it is determined at step 309 that the TV switch is not turned on (NO at step 309), it is judged at step 312 whether or not the cellular phone is receiving an incoming call.

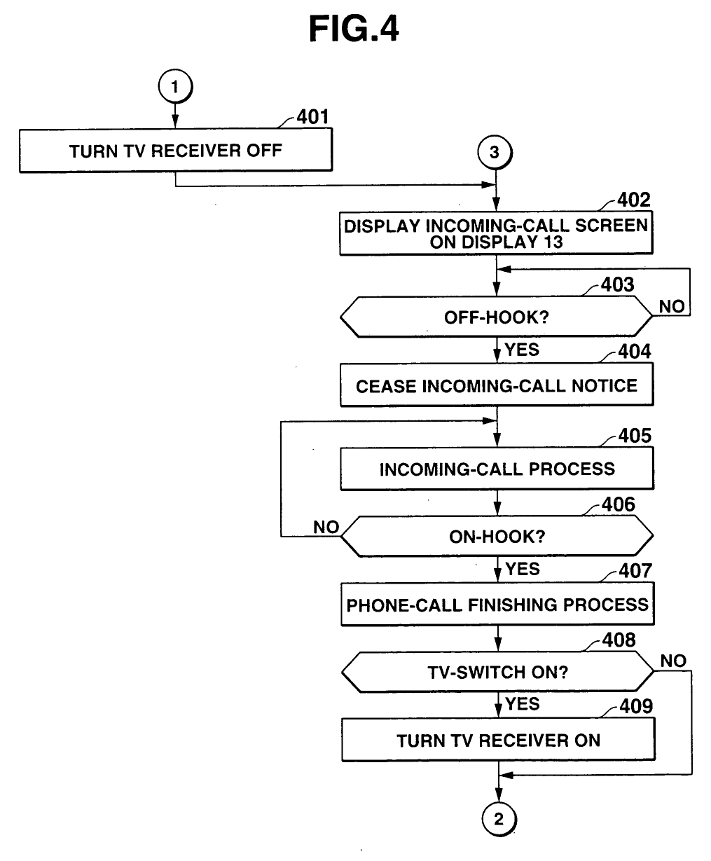

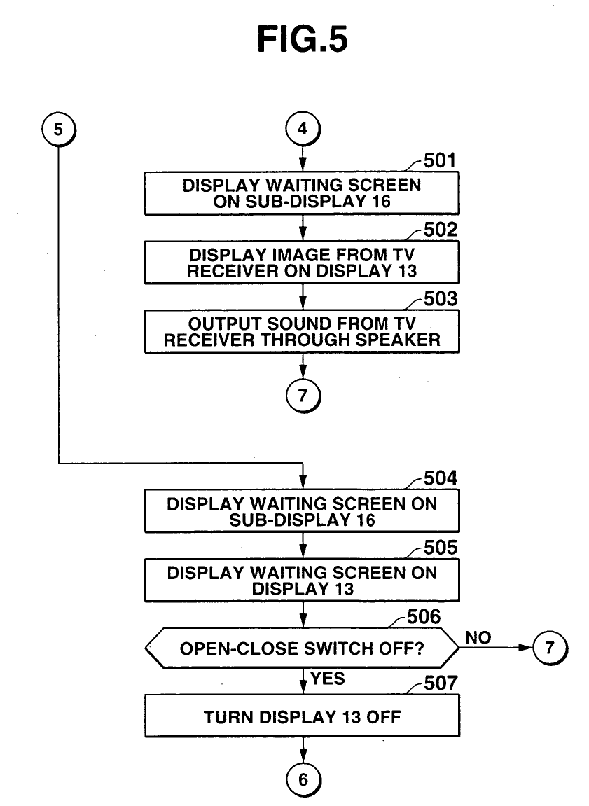

When it is determined at step 310 that the cellular phone is receiving an incoming call (YES at step 310), the cellular phone is brought to the phone-call mode (FIG. 4). When it is determined at step 310 that the cellular phone is not receiving an incoming call (NO at step 310), the video image is displayed on the display unit 13 (FIG. 5).

When it is determined at step 312 that the cellular phone is receiving an incoming call (YES at step 312), the cellular phone is brought to the phone-call mode (FIG. 4). When it is determined at step 312 that the cellular phone is not receiving an incoming call (NO at step 312), the video image is displayed on the display unit 13 (FIG. 5).

A process for transiting to the phone-call mode will be described with reference to the flow chart of FIG. 4. When the TV switch is kept on and the cellular phone is receiving an incoming call while the cellular phone is kept in the open state (YES at step 310 in FIG. 3), (or when the user opens the cellular phone for phone call at the time when there is an incoming call while the user is watching a TV program with the cellular phone kept folded), the control section 22 ceases a TV signal processing at step 401 in FIG. 4, and sets the phone-call mode.

When the TV switch is kept off and the cellular phone is receiving an incoming call while the cellular phone is kept in the open state (YES at step 312 in FIG. 3), (or when the user opens the cellular phone for phone call at the time when there is an incoming call while the cellular phone is kept folded), the cellular phone transits to the phone-call mode.

More specifically, the control section 22 displays an incoming-call screen on the display unit 13 at step 402, and judges at step 403 whether or not off-hook operation has been performed. When it is determined at step 403 that off-hook operation is performed (YES at step 403), the control section 22 ceases an incoming-call notice at step 404, and performs an incoming-call process at step 405.

When it is determined at step 406 that on-hook operation is performed (YES at step 406), the control section 22 performs a phone-call finishing process at step 407. When the TV switch is kept on at the moment (YES at step 408), the control section 22 makes the TV signal processing active and returns to the process at step 309 of FIG. 3. In other words, when the TV switch is kept on and the cellular phone is not receiving an incoming call, the TV image is displayed on the display unit 13 (first display unit).

A process for displaying a TV image when the cellular phone is open not for receiving an incoming call will be described with reference to the flow chart shown in FIG. 5.

When the cellular phone is kept in the open state with TV switch turned on and is not receiving an incoming call (NO at step 310 in FIG. 3), a waiting screen is displayed on the subsidiary display unit 16 at step 501.

The control section 22 displays on the display unit 13 a TV image transferred from the TV signal receiving section 200 at step 503 and outputs through the speaker 12 a sound sent from the TV signal receiving section 200 at step 503. The control section 22 goes to a process at step 601.

Meanwhile, when the TV switch is kept off and the cellular phone is not receiving an incoming call while the cellular phone is kept in the open state (YES at step 312 in FIG. 3), the waiting screen is displayed on the subsidiary display unit 16 at step 504, and further displayed on the display unit 13 at step 505.

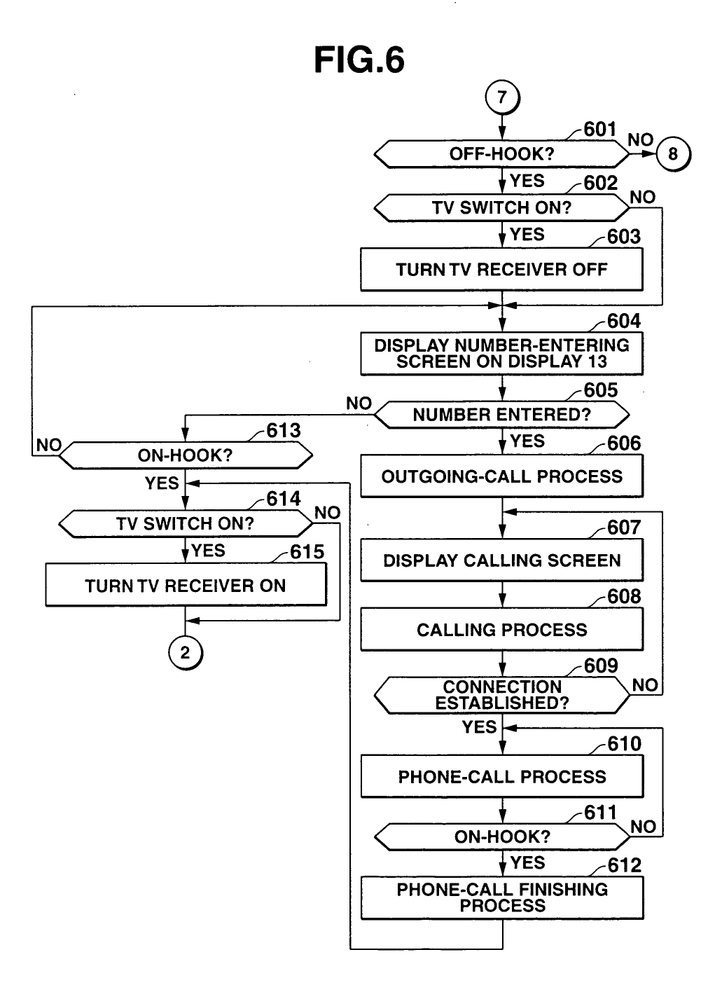

It is judged at step 506 whether or not the open-close switch 30 is kept off. When it is determined at step 506 that the open-close switch 30 is kept off (YES at step 506), then the control section 22 returns to the process at step 306 (FIG. 3). When it is determined at step 506 that the open-close switch 30 is kept on (NO at step 506), then the control section 22 advances to a process at step 601 in FIG. 6.

It is judged at step 601 in FIG. 6 whether or nor off-hook operation has been executed. When off-hook operation is not executed (NO at step 601), the control section 22 advances to a process at step 701. When off-hook operation is executed (YES at step 601), it is judged at step 602 whether or not the TV switch is turned on. When the TV switch is turned on at step 602, the control section 22 ceases the process for displaying TV image and the process for outputting a sound at step 603 to perform the phone call process before other processes.

The control section 22 displays on the display unit 13 a screen for entering a phone number at step 604, and then judges at step 605 whether or not a phone number has been entered.

When the phone number has not been entered at step 605 (NO at step 605), further it is judged at step 613 whether or not on-hook operation has been performed. When on-hook operation is performed at step 613 (YES at step 613), the control section advances to a process at step 614. When on-hook operation is not performed at step 613 (NO at step 613), the control section returns to the process at step 604.

When the phone number has been entered at step 605 (YES at step 605), the control section 22 performs an outgoing-call process in accordance with the entered phone number at step 606, displays an outgoing-call screen at step 607, and a calling process at step 608.

It is judged at step 609 whether a connection has been established. When the connection is not established at step 609 (NO at step 609), the processes at steps 607 and 608 are repeatedly performed until the connection is established. When the connection is established at step 609, the phone-call process is performed at step 610. Thereafter, it is judged at step 611 whether on-hook operation has been performed. When on-hook operation is performed at step 611 (YES at step 611), the control section 22 performs the phone-call finishing process at step 612, and then advances to a process at step 614.

The control section 22 judges at step 614 whether or not the TV switch is kept on. When the TV switch is kept on at step 614 (YES at step 614), the control section 22 makes the TV signal receiving section 200 active, and when the TV switch is not kept on at step 614 (NO at step 614), the control section 22 returns to the process at step 309 in FIG. 3.

The control section 22 judges at step 701 whether the TV switch has been turned on in the cellular phone in the open state receiving no incoming call and with off-hook operation executed. When the TV switch is turned on at step 701 (YES at step 701), the control section 22 makes the TV signal receiving section 200 active, and returns to the process at step 309 in FIG. 3.

When the TV switch is not turned on at step 701 (NO at step 701), the control section 22 judges at step 703 whether or not TV switch has been turned off. When the TV switch is turned off at step 703 (YES at step 703), the control section 22 makes the TV signal receiving section 200 inactive, and returns to the process at step 309 in FIG. 3.

When the TV switch is not turned off at step 703 (NO at step 703), the control section 22 judges at step 705 whether or not the open-close switch 30 is kept off. When the open-close switch 30 is not kept off at step 705 (NO at step 705), the control section 22 returns to the process at step 309 in FIG. 3. When the open-close switch 30 is kept off at step 705 (YES at step 705), the control section 22 makes the display unit 13 inactive, and returns to the process at step 309 in FIG. 3.

Now, an incoming-call detecting process will be described with reference to a flow chart shown in FIG. 8. Upon receipt of an incoming call, the control process 22 notifies the incoming call at step 801, and displays caller data on the subsidiary display unit 16 at step 802, and then returns to the main process.

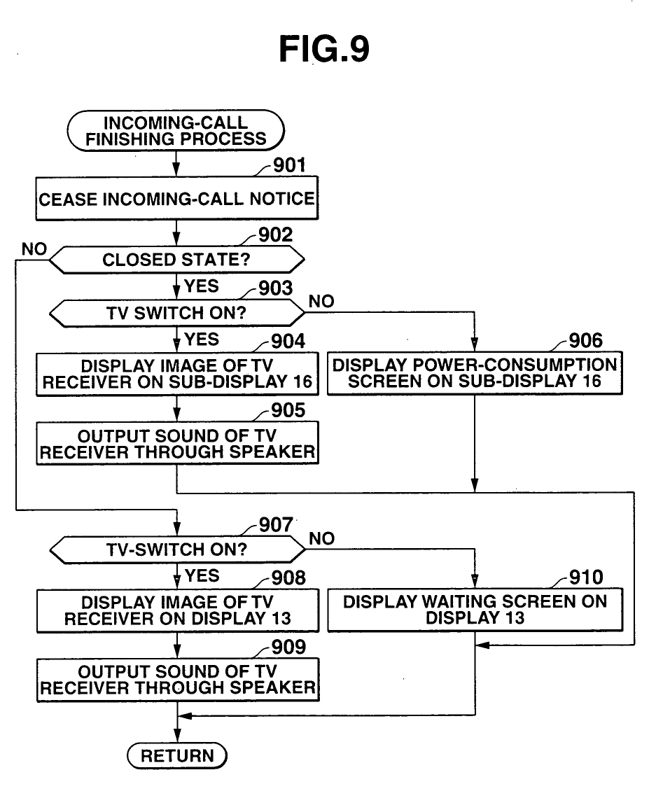

An incoming-call finishing process will be described with reference to a flow chart shown in FIG. 9. When an incoming call finishes, the control section 22 ceases the incoming-call notice at step 901, and judges at step 902 whether the cellular phone is in the folded state or not, and further judges at steps 903 and 907 whether or not the TV switch is kept on.

When the cellular phone is in the folded state and the TV switch is kept on (YES at step 902, YES at step 903), the control section 22 displays a TV image on the subsidiary display unit 16 (second display unit) at step 904, and outputs a TV sound through the speaker 12 at step 905.

When the cellular phone is in the folded state and the TV switch is kept off (YES at step 902, NO at step 903), a screen of less power consumption is displayed on the subsidiary display unit 16 at step 906.

When the cellular phone is in the open state and the TV switch is kept on (NO at step 902, YES at step 903), the control section 22 displays a TV image on the display unit 13 at step 908, and outputs a TV sound through the speaker 12 at step 909.

When the cellular phone is in the open state and the TV switch is kept off (NO at step 902, NO at step 903), the control section 22 displays the waiting screen in the display unit 13 at step 910.

In the first embodiment of the invention described above, when there is an incoming call while the cellular phone is receiving a TV program, the cellular phone automatically transits to the phone-call mode. Therefore, the user of the cellular phone instantly can speak by phone without operating the TV switch, even while the cellular phone is receiving a TV program. For example, even when the cellular phone receives an incoming call while it is in the folded state, and is receiving a TV program, the user can speak instantly by opening the phone and performing off-hook operation in a similar manner as he or she uses a cellular phone with no TV signal receiving function.

In the first embodiment of the invention, the user of the cellular phone is released from troublesome TV-switch operation to be performed at receipt of an incoming call. Meanwhile, if the cellular phone is provided with a memory for storing a TV signal (images and sounds) received during a telephone conversation and for reproducing the same later, the user can enjoy the whole TV program.

Second Embodiment of the Invention

In the cellular phone according to the first embodiment of the invention, the phone is arranged to transit to the phone-call mode and to display the incoming-call screen to perform the phone-call process before other processes. Only a speaker and a microphone of the cellular phone will be necessary for conversation over the phone, and therefore a display unit may be used to display a TV image while the cellular phone is used for speaking.

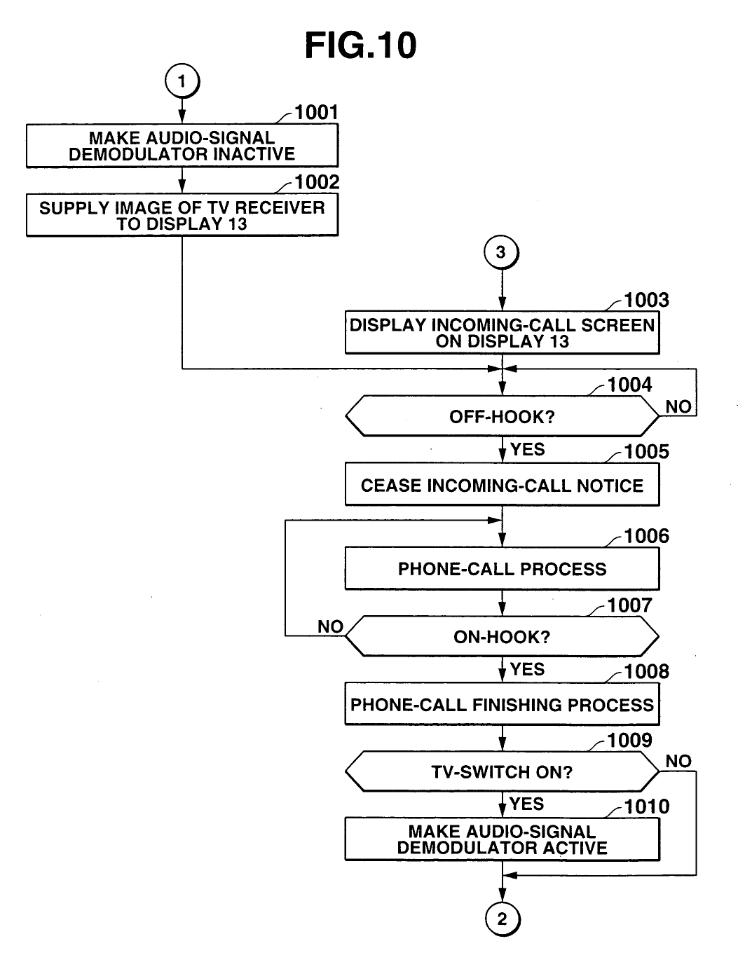

In short, a TV sound can not be heard with such cellular phone. The processes performed in the cellular phone will be described referring to a flow chart of FIG. 10. The flow chart of FIG. 10 corresponds to that of FIG. 4. After the processes shown in FIG. 3 have been performed, the processes of FIG. 10 will be performed, and then the process at step 309 is performed.

When the open-close switch 30 and the TV switch are turned on (YES at step 307, and YES at step 308 in FIG. 3) and the cellular phone is receiving an incoming call (YES at step 310 in FIG. 3), the control section 22 makes the audio signal demodulator 205 inactive at step 1001 in FIG. 10, and keeps the video signal demodulator 204 active to display a TV image on the display unit 13 (first display unit) at step 1002.

When the open-close switch 30 is turned on and the TV switch is turned off (YES at step 307 and NO at step 309) and the cellular phone is receiving an incoming call (YES at step 312), the control section 22 displays an incoming screen on the display unit 13 at step 1003.

The control section 22 judges at step 1004 whether or not off-hook operation has been performed. When off-hook operation is performed (YES at step 1004), the control section 22 ceases the incoming-call notice at step 1005 and performs the phone-call process at step 1006.

When on-hook operation is performed (YES at step 1007), the phone-call finishing process is executed at step 1008. When the TV switch is kept on (YES at step 1009), the control section 20 makes the audio signal demodulator 205 active at step 1010, and returns to the process at step 309 of FIG. 3.

In the cellular phone according to the second embodiment of the present invention, the control section 22 displays a TV image on the display unit 13 and outputs a TV sound as far as it is not receiving an incoming call. The user of the cellular phone can enjoy at least a TV image even if the cellular phone is receiving an incoming call or is being used for speaking. The cellular phone may be modified to display caller data on the subsidiary display unit 16 while it is receiving an incoming call, as shown in the flow chart of FIG. 8. The above modification to the cellular phone allows the user to confirm to whom the user is talking.

Third Embodiment of the Invention

In the cellular phone according to the second embodiment, a TV image is left displayed on the display unit in the phone-call mode, but modification may be made to the cellular phone such that a display area of the display unit is divided into two areas, one for displaying a TV image and other for displaying caller data.

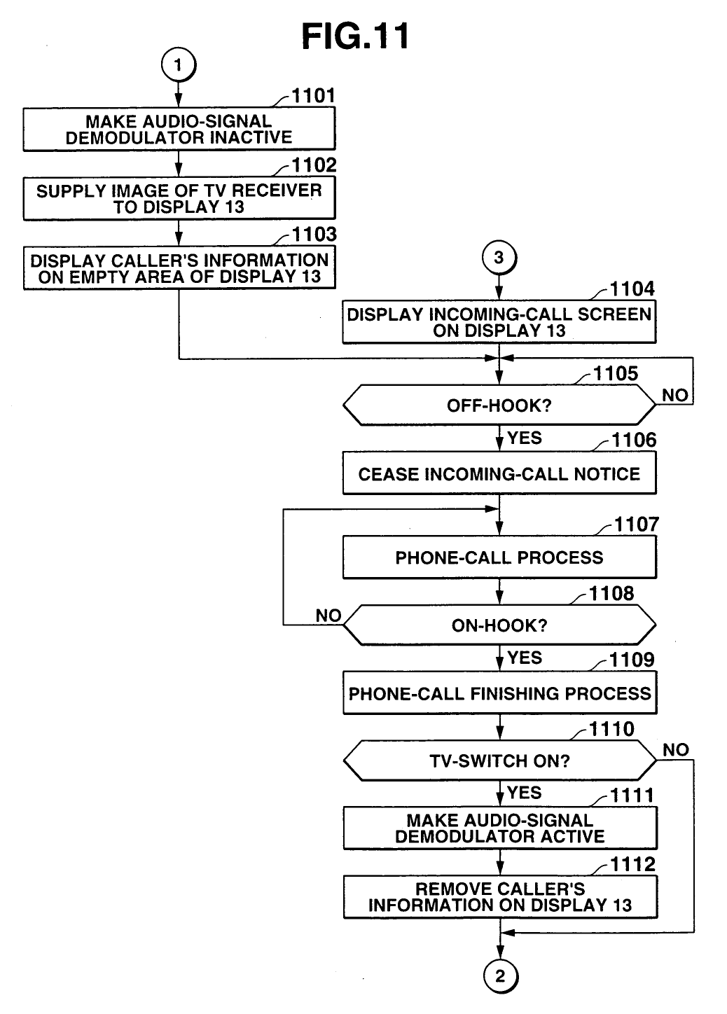

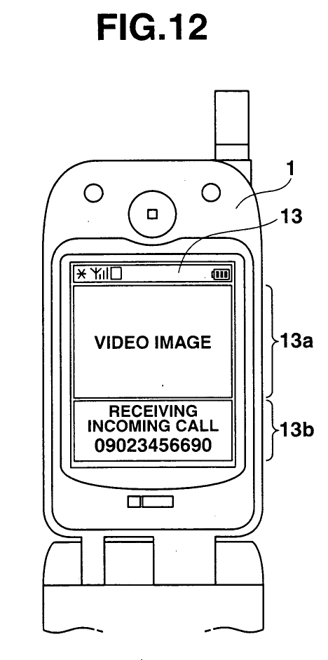

The processes performed in the modified cellular phone will be described with reference to a flow chart shown in FIG. 11. A sample of the display screen is illustrated in FIG. 12.

In FIG. 2, the display area of the display unit 13 is divided into two areas 13a, 13b. The area 13a occupies more than half of the whole display area of the display unit 13 for displaying a TV image, and the other lower area occupies less than one third of the whole display area for displaying an incoming-call display and a caller's number.

FIG. 11 is a flow chart showing a part of the process to be performed in the third embodiment. The flow chart of FIG. 11 corresponds to that shown in FIG. 4. After the processes shown in FIG. 3 have been performed, the processes of FIG. 10 are performed, and then the process at step 309 is performed.

When the open-close switch 30 and the TV switch are turned on (YES at step 307, and YES at step 308 in FIG. 3) and the cellular phone is receiving an incoming call (YES at step 310 in FIG. 3), the control section 22 makes the audio signal demodulator 205 inactive at step 1101 in FIG. 11, and keeps the video signal demodulator 204 active to display a TV image on the display unit 13 (first display unit) at step 1102.

The control section 22 displays caller's data on the display area 13a of the display unit 13 at step 1103 in FIG. 12. When the open-close switch 30 is turned on and the TV switch is turned off (YES at step 307 and NO at step 309) and the cellular phone is receiving an incoming call (YES at step 312), the control section 22 displays an incoming screen on the display unit 13 at step 1104.

The control section 22 judges at step 1105 whether or not off-hook operation has been performed. When off-hook operation is performed (YES at step 1105), the control section 22 ceases the incoming-call notice at step 1106 and performs the phone-call process at step 1107.

When on-hook operation is performed (YES at step 1108), the phone-call finishing process is executed at step 1109. When the TV switch is kept on (YES at step 1110), the control section 20 makes the audio signal demodulator 205 active at step 1111, and releases division of the display area of the display unit 13 at step 1111, and then returns to the process at step 309 of FIG. 3.

In the cellular phone according to the third embodiment of the invention, the control section 22 displays a TV image on the display unit 13 and outputs a TV sound, if it is not receiving an incoming call.

The user of the cellular phone can enjoy at least a TV image even though the cellular phone is receiving an incoming call or is being used for speaking. Further, since the display area of the display unit 13 of the cellular phone is divided to secure a display portion for displaying caller data, the user can enjoy convenience as provided by a conventional cellular phone upon receipt of an incoming call.

Modification may be made to the cellular phone according to the invention such that the user can select previously either of the processes executed in the first, the second and the third embodiment. For example, the user can give priority to either of functions at receipt of an incoming call, such as a function of talking first, a function of TV-image display, or a function of TV-image and caller's data display, and respond in accordance with the function to which the priority has been given.

Although the present invention has been described in detail with reference to the embodiments, it will be obvious to those skilled in the art that many modifications and changes may be made to the disclosed embodiments, all of which will be within the scope of the invention as described and defined herein.

1. A cellular phone which has a cover portion and a body portion, the cover portion and the body portion being connected to each other by a hinge, and which can be held either in an open state or in a folded state, comprising:
a television-signal receiving section for receiving a television broadcasting wave;
a phone-call control section for detecting an incoming call to control a phone-call process;
a signal-reception control section for controlling operation of the television-signal receiving section, and for outputting a video image of the television broadcasting wave received by the television-signal receiving section, while placing the television-signal receiving section in operation;
a switch for judging whether the cellular phone is kept in the folded state or in the open state; and
an off-control section for causing the signal-reception control section to place the television-signal receiving section out of operation, when the switch detects that the cellular phone has been brought to the open state after the phone-call control section detects an incoming call with the cellular phone held in the folded state and with the television-signal receiving section placed in operation.

2. The cellular phone according to claim 1, further comprising:
a second display unit provided on another surface of the cover portion; wherein the video image of the television broadcasting wave received by the television-signal receiving section is displayed on the second display unit, when the switch detects that the cellular phone is kept in the folded state and the signal-reception control section places the television-signal receiving section in operation.

3. The cellular phone according to claim 1, further comprising:
a display unit provided on a surface of the cover portion, which surface faces a surface of the body portion when the cellular phone is kept in the folded state; wherein the signal-reception control section displays on the display unit the video image of the television broadcasting wave received by the television-signal receiving section, in case that the signal-reception control section places the television-signal receiving section in operation, the switch detects that the cellular phone is in the open state, and the phone-call control section detects no incoming call.

4. A cellular phone which has a cover portion and a body portion, the cover portion and the body portion being connected to each other by a hinge, and which can be held in an open state or in a folded state, comprising:
a display unit provided on a surface of the cover portion, which surface faces a surface of the body portion when the cellular phone is kept in the folded state;
a television-signal receiving section for receiving a video signal and an audio signal of a television broadcasting wave;
a phone-call control section for detecting an incoming call to control a phone-call process;
a signal-reception control section for controlling operation of the television-signal receiving section, and for outputting to the display unit the video signal of the television broadcasting wave received by the television-signal receiving section, while placing the television-signal receiving section in operation;
a sound outputting section for outputting either an audio signal processed in the phone-call process by the phone-call control section or the audio signal of the television broadcasting wave received by the television-signal receiving section;
a switch for judging whether the cellular phone is kept in the folded state or in the open state; and
a sound switching section for transferring to the sound outputting section the audio signal processed in the phone-call process by the phone-call control section in place of the audio signal of the television broadcasting wave received by the television-signal receiving section, when the switch detects that the cellular phone has been brought to the open state after the phone-call control section detects an incoming call with the cellular phone held in the folded state and with the television-signal receiving section placed in operation and with the sound outputting section outputting the audio signal of the television broadcasting wave received by the television-signal receiving section.

5. The cellular phone according to claim 4, wherein the signal-reception control section displays on the display unit the video image of the television broadcasting wave received by the television-signal receiving section, when the switch detects that the cellular phone is kept in the open state after the phone-call control section detects an incoming call with the cellular phone kept in the folded state and with the television-signal receiving section placed in operation.

6. The cellular phone according to claim 4, further comprising:
a second display unit provided on another surface of the cover portion; wherein the video image of the television broadcasting wave received by the television-signal receiving section is displayed on the second display unit, when the switch judges that the cellular phone is kept in the folded state and the signal-reception control section places the television receiving section in operation.

7. A cellular phone which has a cover portion and a body portion, the cover portion and the body portion being connected to each other by a hinge, and which can be held in an open state or in a folded state, comprising:
a display unit provided on a surface of the cover portion, which surface faces a surface of the body portion when the cellular phone is kept in the folded state;
a television-signal receiving section for receiving a video signal and an audio signal of a television broadcasting wave;
a phone-call control section for detecting an incoming call to control a phone-call process;
a signal-reception control section for controlling operation of the television-signal receiving section, and for displaying on the display unit the video signal of the television broadcasting wave received by the television-signal receiving section, while placing the television-signal receiving section in operation;
a sound outputting section for outputting either an audio signal processed in the phone-call process by the phone-call control section or the audio signal of the television broadcasting wave received by the television-signal receiving section;
a switch for judging whether the cellular phone is kept in the folded state or in the open state; and
an incoming-call display control section for displaying on an empty display area of the display unit information of the incoming call, when the switch detects that the cellular phone has been brought to the open state after the phone-call control section detects an incoming call with the cellular phone held in the folded state and with the television-signal receiving section being placed in operation.

8. The cellular phone according to claim 7, wherein the information that the incoming-call display control section displays on the empty display area of the display unit includes caller's information.

9. The cellular phone according to claim 7, further comprising:
a sound switching section for outputting to the sound outputting section the audio signal processed in the phone-call process by the phone-call control section in place of the audio signal of the television broadcasting wave received by the television-signal receiving section, when the switch detects that the cellular phone has been brought to the open state after the phone-call control section detects an incoming call with the cellular phone held in the folded state and with the television-signal receiving section being placed in operation and with the sound outputting section outputting the audio signal of the television broadcasting wave received by the television-signal receiving section.
